(19) United States
(12) Patent Application Publication
(10) Pub. No.: US 2012/0126461 A1
(43) Pub. Date: May 24, 2012

(54) METHOD FOR CHANGING MOLDING CAVITIES FOR A STATION FOR BLOW-MOLDING PLASTIC CONTAINERS, AND DYNAMIC STORAGE DEVICE

(75) Inventors: Yves-Alban Duclos, Octeville sur Mer (FR); Severine Valer, Octeville sur Mer (FR)

(73) Assignee: SIDEL PARTICIPATIONS, Octeville sur Mer (FR)

(21) Appl. No.: 13/388,124

(22) PCT Filed: Sep. 6, 2010
(86) PCT No.: PCT/EP10/63014

§ 371 Date: Jan. 31, 2012

(30) Foreign Application Priority Data
Sep. 7, 2009 (FR) 0956078

(51) Int. Cl. B29C 49/18; B29C 49/38

(52) U.S. Cl. 264/523; 425/182

(57) ABSTRACT

A method for changing cavities (24) for molding containers for a blow-molding station (14), including: a plurality of mold carrier units (22), each having a first mold (16A) consisting of a plurality of portions that are capable of being attached together so as to form a first cavity (24A); a first element for arranging the first attached molds (16A); and a second element for arranging the second attached molds (16B). The method for changing all of the first cavities (24A) includes at least one first pre-preparation step (E1) during which all of the second molds (16B) are stored in the detached state on a first intermediate storage stand (39, 54) while the blow-molding station (14) still produces containers using the first molds (16A). The invention also relates to a dynamic storage device.

The invention relates to a method for the changeover of the molding cavities of a blow molding or stretch-blow molding station for producing containers.

The invention more particularly relates to a method for the changeover of the molding cavities of a blow molding or stretch-blow molding station for producing containers, in particular bottles, made from thermoplastic material, with the blow molding station comprising:
a plurality of first molds comprising at least two molding elements each of which is provided with a portion of a first container molding cavity, with each mold being able to occupy a molding position in which the constituent molding elements are mated to form the first molding cavity;
a plurality of mold carriers which are carried by a carousel, with each mold carrier movably carrying a first mold between a closed position in which the first associated mold occupies its molding position, and an open position in which the molding elements of said first mold are unmated;
a first storage means for all the first molds in their molding positions;
a second storage means for a plurality of second molds which are similar to the first molds and which comprise a second molding cavity, with all the second molds being stored in their molding positions;

the method for the changeover of all the first molding cavities comprising for each mold carrier at least a first preparation stage during which molding elements of a second mold are unmated then stored on a first intermediate storage support before being mounted on a mold carrier stopped in an indexed angular replacement position at a subsequent second replacement stage.

These blow molding stations are used to produce containers, in particular bottles, made from thermoplastic material using either blow molding or stretch-blow molding technology.

To make their products attractive and original, beverage retailers frequently seek to give their bottles original shapes.

This tendency has repercussions on the operation of bottle production lines, with the result that bottle producers are required to make frequent changes to their blow molding station molding cavities in order to obtain bottles of the desired shape.

To simplify these changes, the applicant has already proposed, in particular in document EP-A-0 821 641, to reduce the number of parts which need to be changed by disassociating:
the means for regulating the mold temperature which are permanently fixed on the mold carrier; and
the mold proper which carries the bottle's molding cavity.

Thus, when changing over a molding cavity, only the mold is changed. The mold is a lot more lightweight because its volume is smaller than that of a solution in which the regulation means are incorporated in the mold.

This solution has proven to be highly satisfactory and has already enabled the length of a molding cavity changeover operation to be considerably reduced. In addition, the molding cavity changeover operation can now be carried out by a single operator.

In the following description and in the claims, the molds to be changed will be called “first molds” and the replacement molds will be called “second molds”. The first and second molds are similar in structure so that a mold carrier can carry both types.

During a molding cavity changeover operation, an operator stops the mold carrier carousel so that at least one mold carrier fitted with a first mold to be changed is stopped in an indexed replacement position. This indexed replacement position is arranged to coincide with a work area where the operator has sufficient free surface area to change the mold.

The fact that the mold carrier can be stopped for a sufficiently long time to allow the molding cavity changeover operation to be carried out of course requires the blow molding station to be taken offline until all the molds have been replaced.

At a first preparation stage, molding elements of a second replacement mold are unmated then stored separately on a first intermediate storage support. The intermediate storage support conventionally comprises a table arranged in the work area.

A second replacement stage is then commenced. This second stage comprises three successive phases.

At a first opening phase, the mold carrier which has been stopped in the indexed angular replacement position is opened to give access to the fixing means of the molding elements of the first mold on their support.

Then, at a second removal phase, each molding element carried by said mold carrier is removed then stored on a second clear intermediate storage support. The intermediate storage support traditionally comprises a clear space on said table arranged in the work area.

Then, at a third mounting phase, the molding elements of said second mold which was stored at the first stage, are successively mounted on the associated supports of said mold carrier to replace the molding elements removed during the second removal phase.

Finally, at the end of the second replacement stage, a third storage stage is commenced. During this third stage, said first mold removed is assembled then stored in a first storage means.

The assembly operation ensures the molds are compactly stored.

This operation also ensures that the molding elements are always used together in the same mold. This simplifies identification of defective molding elements.

The three stages of the molding cavity changeover method which have just been described are successively repeated from the first stage up until the third stage for each of the mold carriers of the blow molding station and which are successively stopped in the indexed replacement position by control means actuated by the operator.

This molding cavity changeover method, however, requires the entire bottle production line to be shut down. Thus, although the method described above has already proven satisfactory, shortening the production line's downtime would be highly desirable in terms of production time and costs.

In addition, the cost of this molding cavity changeover method in terms of time represents a considerable stress for the operator in charge of the changeover operation.

To resolve these problems, this invention proposes an improved molding cavity changeover method of the type described above and characterized in that the first preparation stage is carried out for all the second molds while the blow molding station continues to produce containers using the first molds, with said second molds being stored unmated on a plurality of associated intermediate storage supports which are arranged near to the indexed replacement position.

According to other features of the method according to the invention:
the method comprises a second replacement stage which is commenced at the end of the first stage when the blow molding station has been taken offline and during which:
at a first indexing and opening phase, a mold carrier is stopped in an indexed angular replacement position;
then, at a second removal phase, the molding elements of the first mold carried by said mold carrier are removed then stored unmated on a second clear intermediate storage support;
then, at a third mounting phase, the molding elements of one of the second molds which was stored at the first preparation stage is mounted on said mold carrier;
the method comprises a third storage stage during which the first molds removed during the second stage are mated then stored in the first storage means, with the third storage stage being commenced once all the first molds have been removed and once the blow molding station has been put back online to produce containers using the second molds.

The invention also relates to a device for implementing the method, characterized in that the first preparation stage is carried out for all the second molds designed to be mounted on the blow molding station during the method while the blow molding station continues to produce containers using the first molds, with said second molds being stored unmated on a plurality of associated intermediate storage supports which are arranged near to the indexed replacement position.

According to other characteristics of the device according to the invention:
the intermediate storage supports are movably mounted along a closed circuit;
the dynamic storage device comprises at least one intermediate storage support more than the number of mold carriers provided in the blow molding station so that there is one clear storage support available at all times to deposit the molding elements removed from a first mold;
the travel of the intermediate storage supports is synchronized with the rotation of the carousel of the blow molding station so that the clear intermediate storage support and a storage support carrying a second mold are moved up to a fixed work position located near to the mold carrier fitted with a first mold stopped in its angular changeover position;
the intermediate storage supports are carried by a carousel;
the carousel is a horizontal carousel;
the intermediate storage supports are carried by at least one horizontal conveyor;
the carousel is a vertical carousel in which the intermediate storage supports are formed or carried by platforms.

Further features and advantages will emerge from reading the description which follows which shall be understood with reference to the accompanying drawings in which:

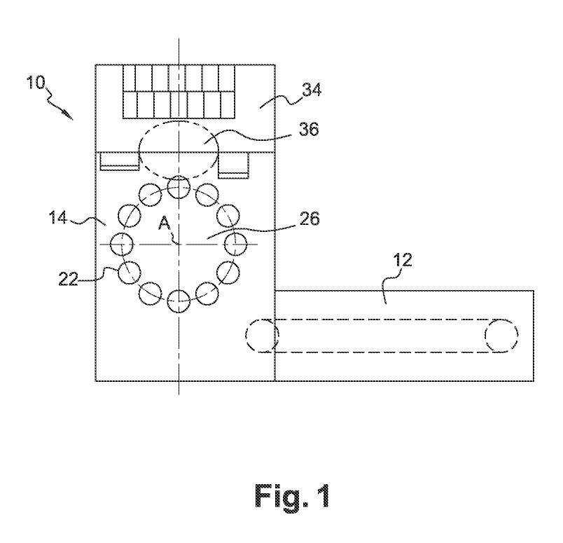

FIG. 1 is a plan view schematically showing a blow molding or stretch-blow molding machine for producing plastic containers;

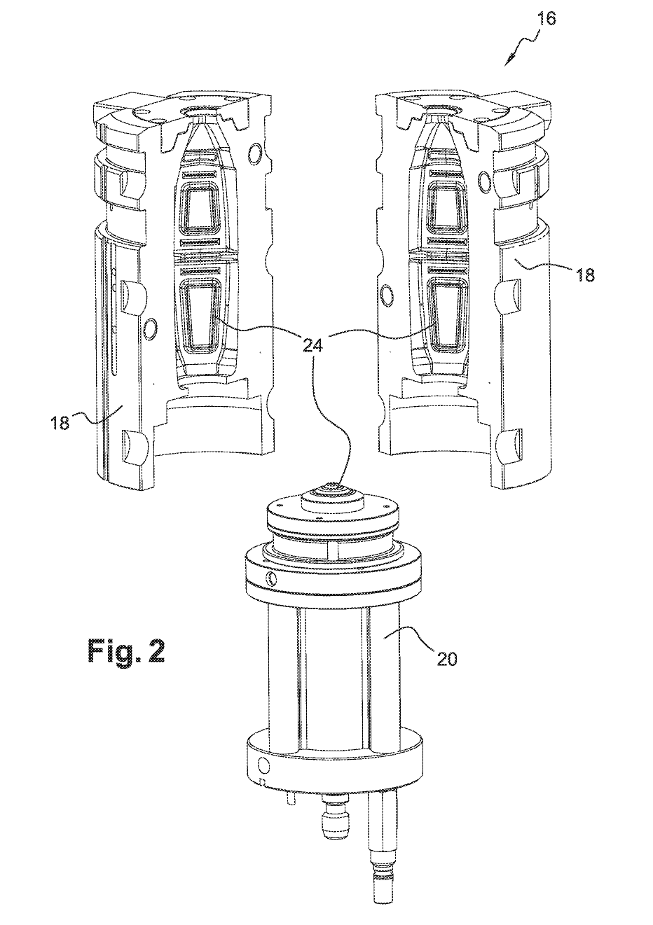

FIG. 2 is a perspective view showing a mold in an unmated position which can be mounted on a mold carrier of the blow molding station of FIG. 1;

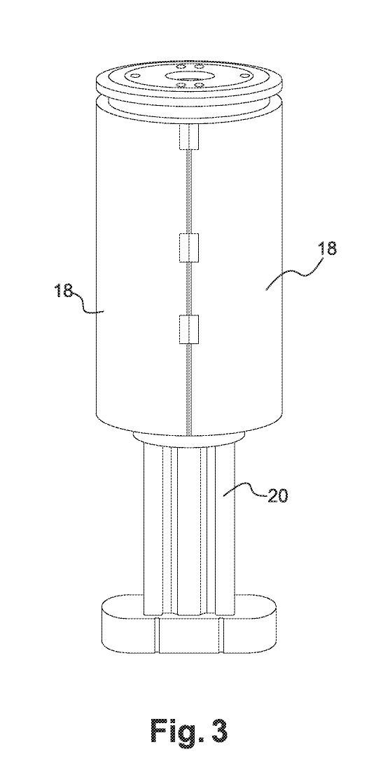

FIG. 3 is a perspective view showing the mold of FIG. 2 in a molding position;

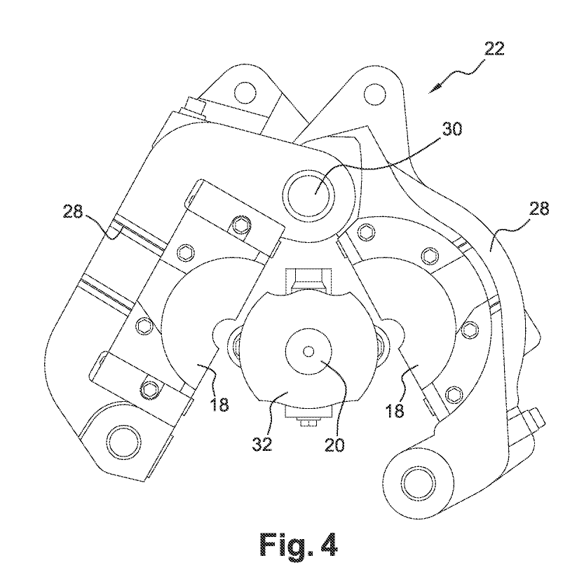

FIG. 4 is a plan view showing a mold carrier which is fitted with a first mold and which is in an open position;

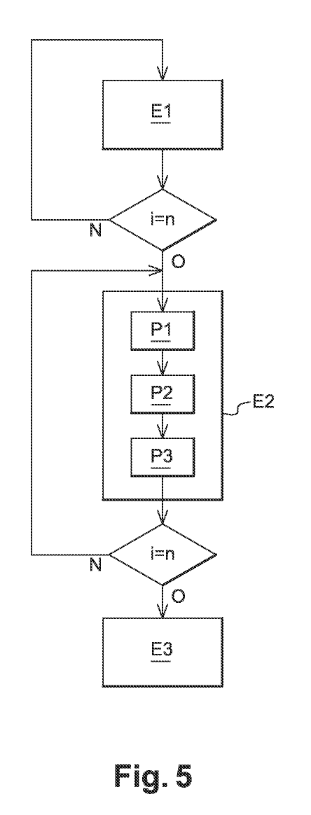

FIG. 5 is a diagram showing the stages of the molding cavity changeover method made in accordance with the disclosures of the invention;

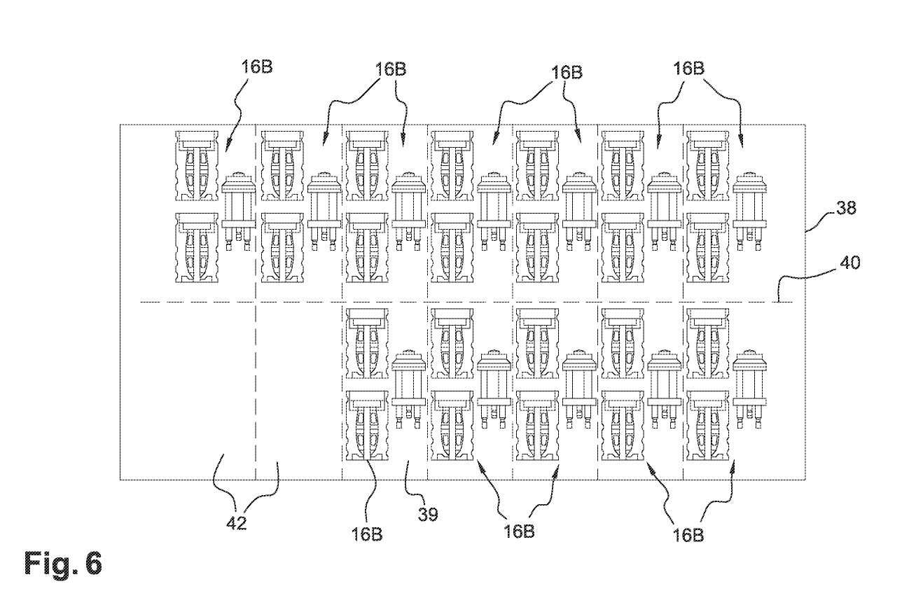

FIG. 6 is a plan view showing an intermediate storage table on which second molds are lying in an unmated position;

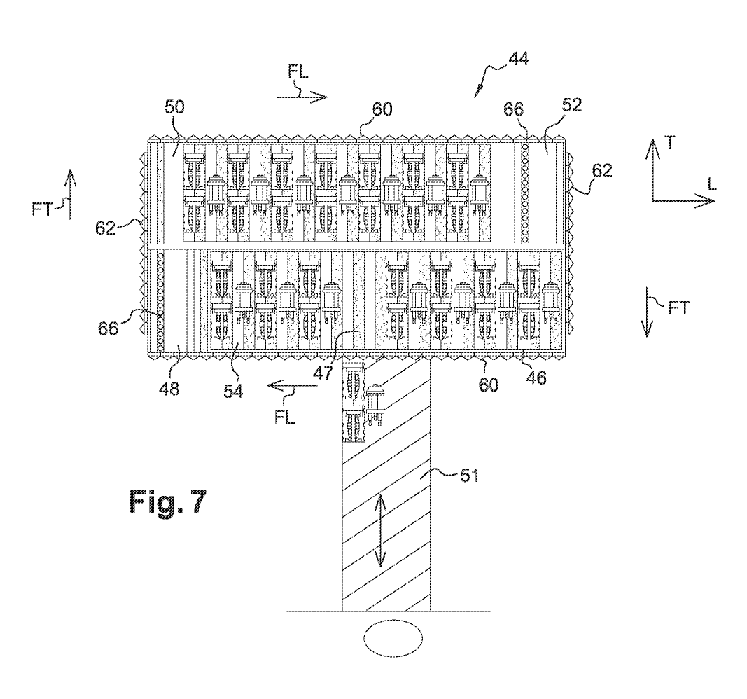

FIG. 7 is a plan view showing a dynamic storage device made according to a first embodiment of the invention on which second molds are lying in an unmated position;

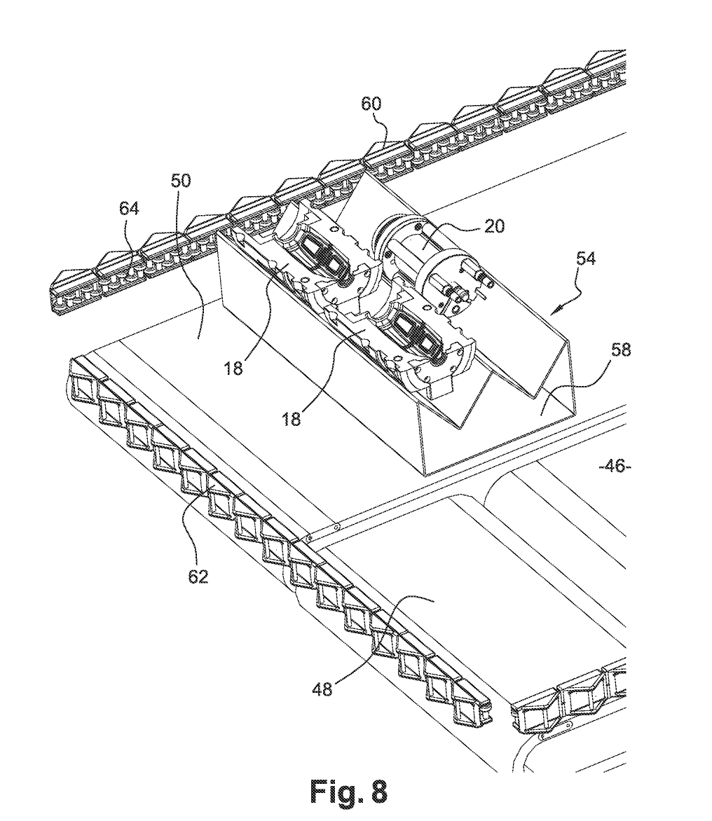

FIG. 8 is a perspective view showing an intermediate storage support of the device of FIG. 7;

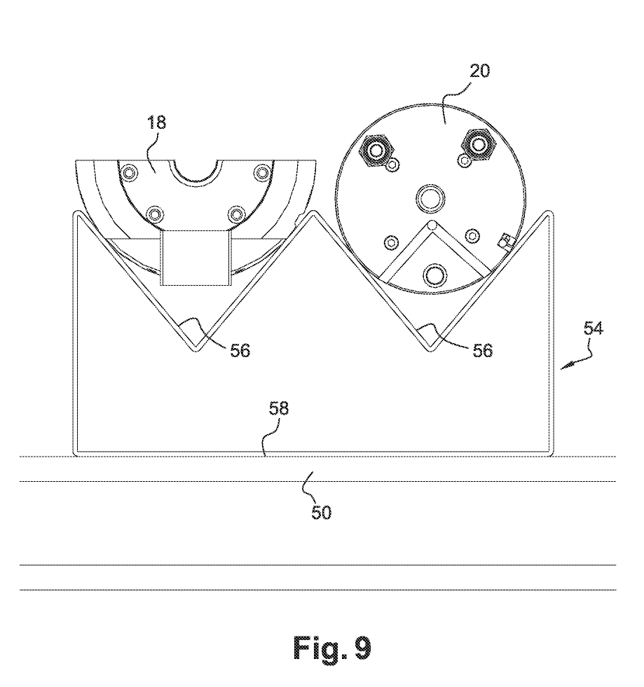

FIG. 9 is a front view of the intermediate storage support of FIG. 8;

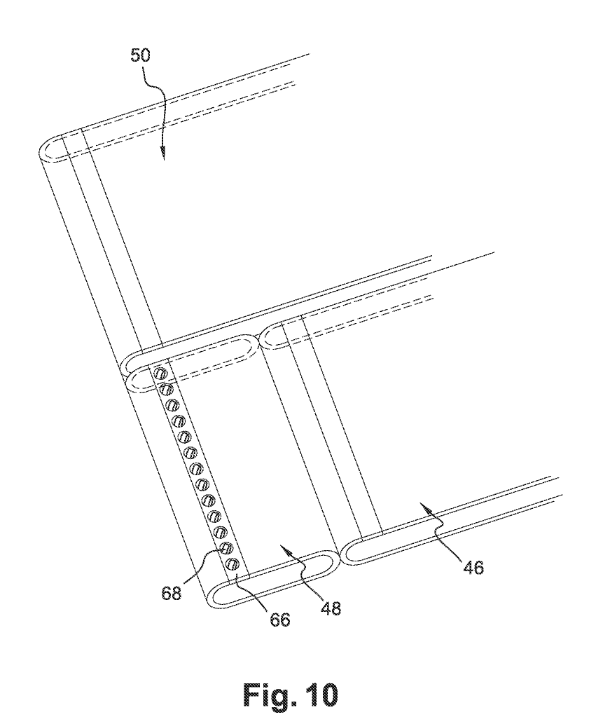

FIG. 10 is a detailed view showing an end conveyor belt comprising slanted rolling bearings which allow transverse transfer of the intermediate storage supports;

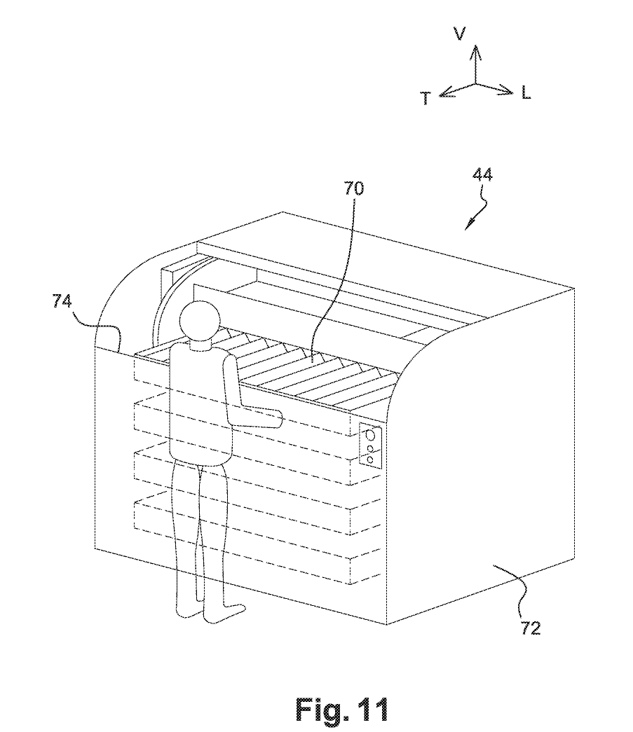

FIG. 11 is a perspective view showing a dynamic storage device made according to a second embodiment of the invention;

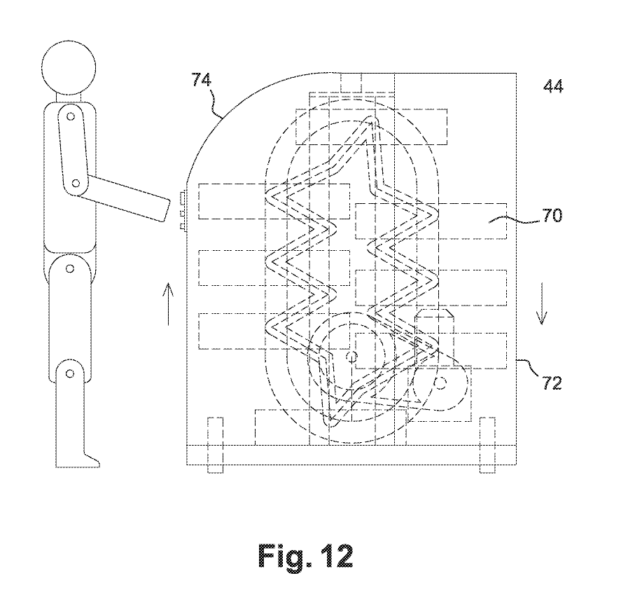

FIG. 12 is a side view showing the dynamic storage device of FIG. 11;

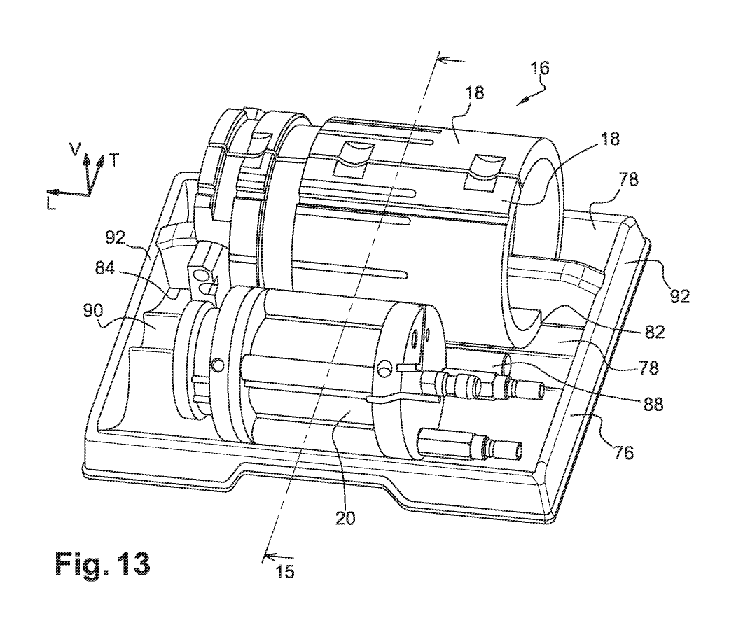

FIG. 13 is a perspective view of a mold storage platen;

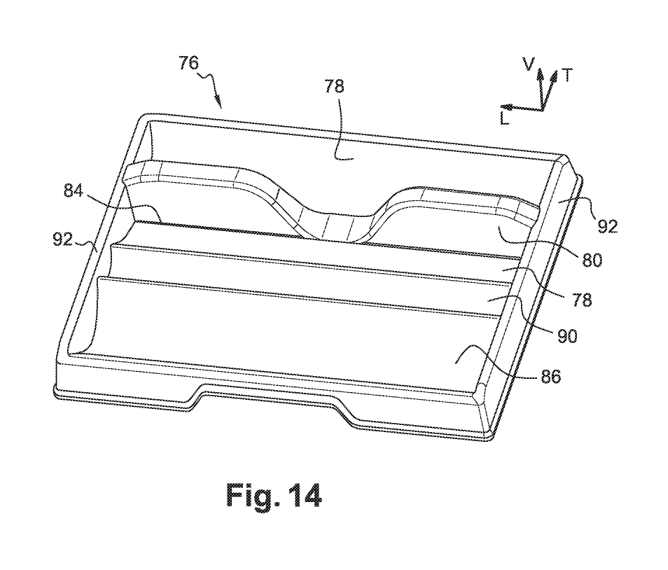

FIG. 14 is a view similar to that of FIG. 13 in which only the platen is shown;

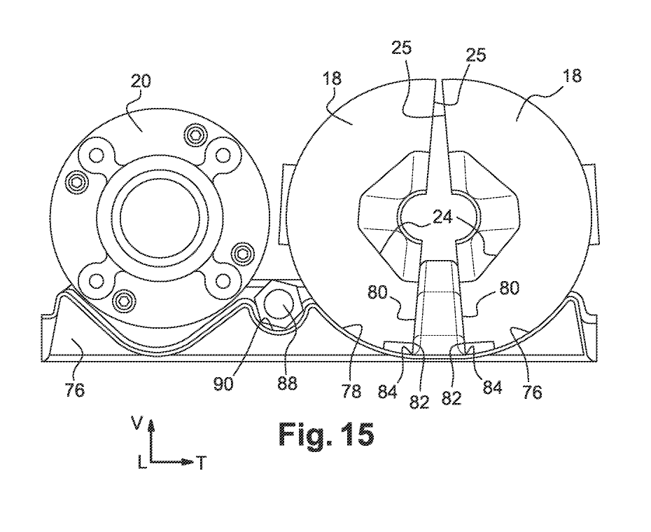

FIG. 15 is a cross-sectional view along the cross-sectional plane 15-15 of FIG. 13.

In the rest of the description, the letters “L, V, T” in the figures will be used in a non-limiting manner to indicate longitudinal, transverse and vertical orientations.

In the rest of the description, elements performing analogous, similar or identical functions will be designated by the same reference numbers.

FIG. 1 shows an installation 10 for the production of containers, in particular bottles, made from thermoplastic preforms or parisons (not shown).

The installation 10 comprises, in particular, an oven 12 and a blow molding or stretch-blow molding station 14. The preforms are automatically conveyed into the oven 12 to be preheated up to a sufficiently high temperature to allow their subsequent shaping by blowing in the blow molding station 14.

The blow molding of the containers takes place in a mold 16, such as the one shown in FIGS. 2 and 3, which is fitted with a hollow molding cavity 24 into which a preheated preform, generally of thermoplastic material, is introduced. This preform is then pressurized to give it a desired shape in accordance with that of the molding cavity.

Document FR-A-2 764 544 may be referred to, for example, for further details of the blow molding or stretch-blow molding means.

As shown in FIG. 2, molds 16 generally comprise three parts: two half-molds 18, articulated in a plane perpendicular to a main vertical axis of the mold 16, either translationally or rotatably, about a common hinge (with the mold 16 then being said to be of the “billfold” type), and a mold bottom piece 20 which can be displaced parallel to the axis of the mold 16.

More particularly, the half-molds 18 and the mold bottom piece 20 form a set of molding elements 18, 20 each of which is fitted with a portion of the molding cavity 24 of the container.

Each half-mold 18 more particularly has a mating face 25 which is designed to be pressed against the mating face 25 of the other half-mold 18 in an assembled position of the two half-molds 18. A portion of the molding cavity 24 is hollow in each mating face 25.

Each mold 16 can thus occupy a molding position, as shown in FIG. 3, in which the molding elements constituting the mold 16 are mated to form the container's molding cavity 24, and an unmated position, as shown in FIG. 2, in which the molding elements 18, 20 are separated from one another so that the container can be ejected after blowing.

In its molding position, the mold 16 has a substantially cylindrical shape.

The blow molding station 14 in FIG. 1 is designed to produce containers on a very fast-moving production line. The duration of a blowing cycle for each mold 16 is of the order of a few seconds. To further increase container production capacity, the blow molding station 14 comprises a plurality of molds 16 which are carried by a carousel 26 using support elements called “mold carriers 22”. The carousel 26 is mounted rotatably about a vertical axis “A”.

As illustrated in FIG. 4, each mold carrier 22 comprises at least two supports 28, 32 on each of which an associated molding element 18, 20 can be mounted.

In the example described herein, the mold carrier 22 is of the so-called “billfold” type. More particularly, it comprises two sections 28 rotatably connected by a hinge 30 with a vertical axis and a movable vertically-slidable mold bottom support 32. Each half-mold 18 can be removably fixed on an associated section 28. The mold bottom piece 20 can be removably fixed on the mold bottom support 32.

The removable fixing means do not constitute subject matter of the present invention. They will therefore not be described below. Examples of such fixing means are described in detail in documents WO-A-2008/000938 and EP-B-0 821 641.

The supports 28, 32 can move between a closed position (not shown) in which the mold 16 occupies its molding position and in which a preform can be subjected to a blowing operation, and an open position, as shown in FIG. 4, in which the molding elements of said mold 16 are unmated so that the container formed after blowing of the preform can be ejected.

In the example shown in FIG. 1, the carousel 26 comprises in this case twelve molds 16. This figure is given as a non-limiting example.

The installation 10 is designed to produce containers of different shapes. Molds 16 are therefore required to be changed, sometimes several times a day, using a changeover method for molding cavities 24 in which the molding elements 18A, 20A of all the first molds 16A in service are replaced by molding elements 18B, 20B of second replacement molds 16B with a second molding cavity 24B.

All the first molds 16A that have an identical molding cavity 24 are generally stored in a first associated storage means such as a moving carriage (not shown) fitted with shelves. The number of identical first molds 16A contained in a carriage is at least the same as the number of mold carriers 22 carried by the blow molding station 14.

The same applies to the second molds 16B which are stored in a second storage means (not shown) which is either identical or similar to the first storage means.

The molds 16A, 16B are generally stored in their molding positions for reasons of compactness. Indeed, as may be seen by comparing FIGS. 2 and 3, a mold 16A, 16B occupies much less space in its molding position.

Furthermore, this method of storing molds in their molding position ensures that the same molding elements 18, 20 are systematically used together to form the same mold 16.

The moving carriages may thus be brought to a work area 34 reserved next to the blow molding station 14. The blow molding station 14 comprises an opening 36, such as a door, leading to the work area 34 so that an operator can access one or more mold carriers 22 once the carousel 26 has been stopped. The accessible mold carriers 22 are “stopped” in an indexed replacement position.

According to a variant of the invention (not shown), in the case of a stretch-blow molding station, each mold is associated with a limit stop which limits the stretching depth of the preform using a stretch rod according to the depth of the molding cavity. The limit stop is removably fitted on the stretch rod. This limit stop is stored with an associated mold. In the rest of the description, this limit stop will be deemed to be a molding element which can be temporarily stored with the half-molds and the mold bottom piece when a molding cavity is changed over.

To be able to replace all the molds 16, the blow molding station 14 comprises means (not shown) for controlling the rotation of the carousel 26 which can be actuated by the operator so that each mold carrier 22 can be selectively stopped in its indexed replacement position. The need to stop the carousel 26 during the molding cavity changeover method requires the blow molding station 14 to be temporarily taken out offline.

The invention proposes an improved method for the changeover of molding cavities 24 which reduces the length of time that the blow molding station 14 is offline. This method will now be described in detail with reference to FIG. 5.

During a first preparation stage “E1”, the carriage containing the second replacement molds 16B is brought near to the work area 34. The molding elements 18B, 20B of the second replacement molds 16B are then unmated.

Each molding element 18B, 20B of a second mold 16B is temporarily stored on a first intermediate storage support 39, as shown in FIG. 6.

This first stage “E1” is repeated for all the second replacement molds 16B before commencing the second stage “E2”. In other words, the first stage “E1” is repeated “n” times, with “n” being the number of mold carriers carried by the carousel 26. In this case, “n” is 12.

The molding elements 18B, 20B of each of the second molds 16B are stored on an associated intermediate storage support 39. These intermediate storage supports 39 are arranged in the work area 34 near to the indexed replacement position.

According to a first embodiment of the invention, which is shown in FIG. 6, the intermediate storage supports 39 comprise emplacements in a table 38 that is sufficiently large to simultaneously accommodate the twelve second molds 16B to be mounted on the blow molding station 14.

Advantageously, the division of the table 38 into emplacements 39 is achieved using lines or partitions which are shown by dotted lines 40 in FIG. 6. This enables the operator to easily identify the molding elements 18B, 20B of one and the same second mold 16B.

In addition, each table portion 39 advantageously comprises wedges (not shown) to keep the molding elements 18, 20 immobile despite their semicylindrical shape.

This first preparation stage “E1” is completed for all the second replacement molds 16B while the blow molding station 14 is still operating, i.e. while the containers made using the first molding cavity 24 are still being produced.

It is advantageous to set the duration of this operation so that the first preparation stage “E1” can be completed before the blow molding station 14 is taken off line. Thus, this first preparation stage “E1” takes place concurrently so that containers can continue to be blow molded during part of the molding cavity changeover method.

At the end of this first preparation stage “E1”, the blow molding station 14 is taken offline.

Once the blow molding station 14 has been taken offline, a second replacement stage “E2” is commenced. This second replacement stage “E2” comprises three successive phases.

At a first indexing and opening phase “P1”, at least one mold carrier 22 is moved to its indexed replacement position. Said mold carrier 22 is then moved to its open position to allow the operator to access the molding elements 18A, 20A of the first mold 16A carried by this mold carrier 22.

Then, at a second removal phase “P2”, the molding elements 18A, 20A removably fixed on said mold carrier 22 are successively removed and stored temporarily on a second clear intermediate storage support 42.

To save time, the removed molding elements 18A, 20A are stored separately in the unmated position.

According to the first embodiment of the invention, which is shown in FIG. 6, the intermediate storage support 42 is formed by a table 38. This is, for example, a clear emplacement 42 in the same table 38 as the one used to store the second molds 16B in their unmated position.

This second removal phase “P2” is repeated for the three molding elements 18A, 20A of said first mold 16A.

Then, at a third assembly phase “P3”, each molding element 18B, 20B of a second mold 16B is mounted on the associated supports, which are now clear, of said mold carrier 22. In order to do this, the molding elements 18B, 20B of said second mold 16B are each successively in turn conveyed from the associated intermediate storage support 39 to a mold carrier 22 in the indexed replacement position, and then fixed to said mold carrier 22.

The three phases “P1” to “P3” of the second stage “E2” are repeated for each mold carrier 22, until all the mold carriers 22 are fitted with a second mold 16B. The blow molding station 14 remains offline throughout this second stage “E2”.

At the time of this repeated action, the intermediate storage support 42 which is clear to hold the molding elements 18A, 20A in the process of being removed is formed by the table emplacement 39 which has been released by the second mold 16B fitted during the previous repeated operation. This advantageously enables space to be saved.

Thus, the table 38 comprises a sufficient number of emplacements 39, 42 to temporarily store at least one mold 16 more than the number of mold carriers 22 possessed by the blow molding station 14. Table 38 shown in FIG. 6 comprises fourteen emplacements 39, 42. In this way, the table comprises two clear emplacements 42 at all times to receive the molding elements 18A, 20A of a first mold 16A.

Generally, in order to avoid using the wrong mold 16, the operator mounts the second mold 16B which is located in emplacement 39 adjacent to the last clear emplacement 42. The operator therefore makes return journeys between the clear emplacement 42 of the table 38 and the mold carrier 22 stopped in the indexed replacement position.

Each time a mold carrier is changed, the clear emplacement 42 “travels” in a clockwise or counterclockwise direction during successive repeats of the second stage “E2”.

Once this second replacement stage “E2” has been repeated for each of the mold carriers 22, the intermediate storage table 38 then only contains the first molds 16A in their unmated position, while all the mold carriers 22 of the blow molding station 14 are fitted with second molds 16B.

The blow molding station 14 can then be put back online to produce containers formed using the second molding cavity 24B.

A third storage stage “E3” of the first sets is commenced once the blow molding station 14 has been put back online to produce containers using the second molds 16B. At this third stage “E3”, the first molds 16A which are stored on the intermediate storage supports 42 are each in turn assembled then stored in an associated storage carriage.

In other words, the molding cavity changeover method according to the invention proposes carrying out each stage “E1” to “E3” for all the molds 16A, 16B before progressing to the following stage whereas in the method according to the state of the art the stages were carried out successively for a mold 16A, 16B at the same time.

This molding cavity changeover method 24 advantageously enables the first preparation stage “E1” and the third storage stage “E3” to take place at the same time, i.e. while the blow molding station 14 is online. This enables the offline time of the blow molding station 14 to be significantly reduced.

Such a method, implemented using an intermediate storage table 38 as shown in FIG. 6, already enables the offline time of the blow molding station 14 to be reduced. However, it is also possible to reduce the offline time by restricting the movements made by the operator compared to this first embodiment in which the operator has to go around the table 38 in order to follow the travel of the clear emplacement 42.

Thus, according to a second embodiment of the invention, the molding cavity changeover method 24 is implemented by replacing intermediate storage table 38 with a dynamic storage device 44 which comprises a plurality of intermediate storage supports 54 each of which is designed to hold the unmated molding elements 18, 20 of a mold 16.

As shown in FIG. 7, the intermediate storage supports 54 are mobile so that they can either automatically, or by means of a control, supply the two molds 16B to be mounted and a clear intermediate storage support 47 to a fixed work position which is arranged in the work area, directly opposite the mold carrier in the indexed replacement position. Thus, the operator's movements merely comprise the shortest return journeys along a passageway 51 between the fixed work position and the mold carrier in the indexed replacement position. Thus, instead of the operator having to follow the clear storage support, it is the clear storage support which is moved to the operator's fixed work position.

In order to reduce the size of the dynamic storage device 44, the intermediate storage supports 54 are movably mounted along a closed circuit.

As explained above in the case of table 38, such a dynamic storage device 44 contains at least one intermediate storage support 54 more than the number of mold carriers 22 provided in the blow molding station 14. Thus, there is always a clear intermediate storage support, which hereinbelow will be numbered 47, to allow the molding elements 18A, 20A of a first mold 16A to be deposited after their removal.

Advantageously, the travel of the intermediate storage supports 54 is synchronized with the rotation of the carousel 26 of the blow molding station 14 so that the clear intermediate storage support 47 and one of the storage supports 54 carrying a second mold 16B are moved as far as the fixed work position located near to the mold carrier 22 fitted with a first mold 16A stopped in its angular changeover position.

The dynamic storage device 44 shown in FIGS. 7 to 10 is formed by a horizontal carousel whose size is similar to that of table 38 of the first embodiment of the invention.

The dynamic storage device 44 mainly comprises two rows of two horizontal conveyor belts 46, 48, 50, 52 which carry platens 54 forming an intermediate storage support. The belts of the two conveyor belts 46, 48 and 50, 52 in the same row turn longitudinally in the same direction.

The two rows of conveyors 46, 48 and 50, 52 are identical about a central line of symmetry. Thus, as indicated by the arrows “FL” in FIG. 7, the conveyor belts 46, 48 of the first row turn so that they pull the platens 54 longitudinally backwards, whereas the conveyor belts 50, 52 of the second row turn so that they pull the platens 54 longitudinally forwards.

Each intermediate storage support is formed by an individual independent platen 54 which can carry the molding elements 18, 20 of a single mold 16. A platen 54 is shown in greater detail in FIGS. 8 and 9.

The molding elements 18, 20 have cylindrical surfaces. To prevent the molding elements 18, 20 from rolling onto the platens 54, each platen 54 has two V-shaped channels 56 arranged in parallel. The channels in this case are orientated in a transverse direction. Thus, as shown in FIG. 9, each molding element 18, 20 is stably wedged between the walls of the channel 56.

Each platen 54 also comprises a flat bottom 58 which lies in contact with the belt of the conveyor belt 46, 48, 50, 52 conveying it.

The platens 54 are distributed in equal numbers on the two longitudinal parallel and neighboring rows of conveyor belts 46, 48, 50, 52.

Each row comprises two conveyor belts 46, 48 and 50, 52. As shown in FIG. 7, a first row 46, 48 feeds the fixed work position, while the second row 50, 52 is transversely separated from the fixed work position by the first row 46, 48.

For each row, a first conveyor belt 46, 50 is designed to convey the platens 54 longitudinally from one end to the other of the row in the direction of the second conveyor belt 48, 52. In the configuration shown in FIG. 7, the first conveyor belt 46 of the first row moves the platens 54 longitudinally backwards, while the first conveyor belt 50 of the second row moves the platens 54 longitudinally forwards.

The first conveyor belts 46, 50 are sufficiently long to carry at least half the platens 54, in this case seven platens.

To prevent the platens falling, the device is framed by longitudinal guide rails 60 and transverse guide rails 62. The rails 60, 62 are fitted with a plurality of rolling bearings 64 of vertical axis which are distributed along the rails 60, 62 to facilitate the travel of the platens.

The rails 62 located at both longitudinal ends of the device extend transversely so as to form an end stop to prevent the platens 54 from falling when they reach the end of the conveyor belt.

As shown in detail in FIG. 10, a second transfer conveyor belt 48, 52 is arranged in the longitudinal extension of the first conveyor belt 46, 50 in the direction of travel of the platens 54 in each row. The second transfer conveyor belt 48, 52 is fitted with at least one transverse batten 66 which carries rolling bearings 68 that are oriented slantwise.

The transfer conveyor belt 48, 52 turns in the same direction as the conveyor belt at the end of which it is arranged. However, the second transfer conveyor belt 48, 52 is much shorter than the first conveyor belt 46, 50. The second transfer conveyor belt has approximately the same length as a platen 54 so that each second transfer conveyor belt 48, 52 can only carry one platen 54 at any one time.

In an immobile state between two turns, the second transfer conveyor belts 48, 52 do not carry any platens 54. All the platens are therefore carried by the first conveyor belts 46, 50 so that there is no available space left on the first conveyor belts 46, 50.

When the carousel 44 rotates, the two rows of conveyor belts 46, 48 and 50, 52 operate synchronously.

The turning of the first conveyor belts 46, 50 causes the platen located at the end of the belt to be longitudinally transferred, in the turning direction of the belt, onto the second transfer conveyor belt 48, 52 located in its extension. This simultaneously causes the release of space on each row at the start of the first conveyor belt 46, 50 to allow a platen 54 to be received from the other row.

When a platen 54 is transferred onto the second transfer conveyor belt 48, 52 by the first transfer conveyor belt 46, 50, the platen 54 is first longitudinally pressed against the end stop rail 62. The platen 54 is thus longitudinally immobilized in the direction of turning of the belt of the second conveyor belt 48, 52.

When a platen 54 is loaded onto the second transfer conveyor belt 48, 52, the first conveyor belt 46, 50 is stopped in order to prevent the platens 54 from piling up against one another.

Then, with the second conveyor belt 48, 52 continuing to turn alone, the slanted rolling bearings 68 pass underneath the bottom 58 of the platen 54. The slanted rolling bearings 68 are then rotated by adhering to the bottom 58. The rotation of the slanted rolling bearings 68 results in the transverse transfer of the platen 54 to the other row by rolling against the end stop rail 62 as indicated by the arrows “FT” in FIG. 7.

Thus, due to this ingenious device, the platens 54 are pulled and moved along a closed circuit in a clockwise direction, as indicated by the arrows “FT, FL” in FIG. 7.

The dynamic storage device 44 is also fitted with control means (not shown) which enable the turning of the conveyor belts 46, 48, 50, 52 to be synchronized. These control means are, for example, actuated by the operator responsible for replacing the molding cavities. The control means thus enable the platens 54 to be moved forward in steps, with a step being equal to the width of a platen 54.

Advantageously, the control means for the dynamic storage device 44 are fitted with a switch (not shown) comprising two conditions which enable the operator to select:
a first condition in which the rotation of the carousel 26 is synchronized with the turning of the conveyor belts 46, 48, 50, 52 during the second stage “E2” of the method for the changeover of the molding cavities 24;
a second condition in which the rotation of the carousel 26 is rendered independent of the turning of the conveyor belts 46, 48, 50, 52 during the first stage “E1” and/or the third stage “E3” of the method for the changeover of the molding cavities 24.

The dynamic storage device 44 is advantageously fitted with castors so that it can be easily moved, for example from one blow molding installation 10 to another.

According to a variant of the invention, not shown, the conveyor belts 46, 48, 50, 52 are replaced by a conveyor of the type used in airports to allow passengers to retrieve their luggage on arrival.

According to a third embodiment, which is shown in FIGS. 10, 11, the dynamic storage device 44 is formed from a vertical carousel.

The principle is the same as for the second embodiment of the invention. Only the differences between these two embodiments will therefore be detailed.

As can be seen more clearly in FIG. 11, this vertical carousel 44 comprises a plurality of platforms 70 which form or carry the intermediate storage supports 54.

The platforms 70 travel along two columns which extend from the ground up to a height determined by the number of platforms 70. The first column is arranged near to the blow molding station 14.

The platforms 70 thus travel around a vertical loop. The platforms 70 are suspended to prevent their content from spilling.

Each platform 70 can in this case carry the molding elements 18, 20 of two molds 16. In other words, one platform 70 forms or carries two parallel intermediate storage supports 54 which are stored longitudinally.

The intermediate storage supports 54 have the same shape as in the first embodiment. They will therefore not be described in greater detail.

The device contains a casing 72 fitted with an opening 74 providing access to a platform 70 which is arranged at an operator's handling height, for example, at the same height as the table 38.

Such an arrangement has the advantage of being very compact in terms of floor space compared to the dynamic storage device of the second embodiment. This is because the raised storage of the molds 16 enables a lot of horizontal space to be saved.

Thus, the molding cavity changeover method associated with a dynamic storage device enables the offline time of the production installation 10 to be reduced enormously.

The examples given above to illustrate the invention will not be regarded as limiting the invention. The invention is applicable to all container blow molding devices comprising removable molds.

According to an embodiment of the invention which is shown in FIGS. 13 to 15, instead of being stored assembled in the storage means, the various molding elements 18, 20 of the molds 16 are stored without being assembled on horizontal platens 76 provided for this purpose.

Each platen 76 is designed to hold the molding elements 18, 20 of an associated mold 16. The platen 76 advantageously has compartments for maintaining each molding element 18, 20 stably in a non-assembled storage position.

The compartments in this case are arranged in parallel. Thus, the various molding elements 18, 20 are arranged transversely one next to the other so that their main longitudinal axes are parallel with one another.

The half-molds 18 are designed to be stored expanded with their mating faces 25 fully vertical, as can be particularly seen in FIG. 15. This position of the half-molds 18 enables the horizontal extension of the platen 76 to be minimized.

The mating face 25 comprising the corresponding mold half-cavity 24 is slightly tilted downwards in order to prevent dust from being deposited thereon. The compartment of each half-mold 18 therefore has a first concave surface 78 which is designed to match the external cylindrical face of said half-mold 18.

In addition, a wedge face 80 slightly tilted relative to the vertical is designed to hold at its bearing surface the mating face 25 of said half-mold 18. An edge 82 bounded by the external cylindrical face and the mating face 25 of the half-mold 25 is designed to be wedged in the angle 84 formed between the wedge face 80 and the concave surface 78. Thus, the half-mold 18 is stably held in its compartment.

The two half-molds 18 are in this case arranged so that their mating faces 25 are opposite one another and a small distance apart in a transverse direction. This enables the depositing of dust on the mating faces 25 to be further restricted. For this purpose, the two concave areas 78 of each compartment are only separated by a wall. Said wall is bounded transversely by the wedge faces 80 of each of the compartments.

The mold bottom 20 also has a cylindrical shape with a longitudinal axis. The mold bottom 20 is designed to be stored lying down. To prevent it from rolling onto the platen 76, it is arranged in a longitudinal channel 86 which transversely wedges the mold bottom 20 in an expanded position while preventing it from rotating.

In the example shown in FIGS. 13 to 15 of a mold 16 designed for a stretch/blow-molding machine, the mold 16 in this case comprises a stretching rod end stop 88. This end stop 88 is in the form of a thin rod. It is arranged between the mold bottom 20 and the half-molds 18. The end stop 88 is arranged in a longitudinal channel 90 modified to prevent it from rotating transversely.

In addition, the plate 76 is longitudinally closed off on both sides by vertical transverse walls 92 with longitudinal ends in order to prevent the molding elements 18, 20, 88 from sliding longitudinally off the platen if the platen 76 were tilted.

Such a platen 76 is very useful because it eliminates the need for the molding elements 18, 20, 88 to be assembled before storage.

In addition, such a platen 76 can be transported by a single operator. Thus, when a mold 16 needs to be replaced, an operator may directly position the platen 76 loaded with the molding elements 18, 20, 88 on the dynamic storage device. This thus enables the assembly and removal operations for molds 16 to be eliminated.

1. A method for the changeover of the molding cavities (24) of a blow molding or stretch-blow molding station (14) for producing containers, in particular bottles, made from thermoplastic material, with the blow molding station (14) comprising:
a plurality of first molds (16A) comprising at least two molding elements (18A, 20A) each of which is provided with a portion of a first container molding cavity (24A), with each mold (16A) being able to occupy a molding position in which the constituent molding elements (18A, 20A) are mated to form the first molding cavity (24A);
a plurality of mold carriers (22) which are conveyed by a carousel (26), with each mold carrier (22) movably carrying a first mold (16A) between a closed position in which the first associated mold (16A) occupies its molding position, and an open position in which the molding elements (18A, 20A) of said first mold (16A) are unmated;
a first storage means for all the first molds (16A) in their molding positions;
a second storage means for a plurality of second molds (16B) which are similar to the first molds (16A) and which comprise a second molding cavity (24B), with all the second molds (16B) being stored in their molding positions;
the method for the changeover of all the first molding cavities (24A) comprising for each mold carrier (22) at least a first preparation stage (E1) during which molding elements (18B, 20B) of a second mold (16B) are unmated then stored on a first intermediate storage support (39, 54) before being mounted on a mold carrier (22) stopped in an indexed angular replacement position at a subsequent second replacement stage (E2),
characterized in that the first preparation stage (E1) is carried out for all the second molds (16B) designed to be mounted on the blow molding station (14) while the blow molding station (14) continues to produce containers using the first molds (16A), with said second molds (16B) being stored unmated on a plurality of associated intermediate storage supports (39, 54) which are arranged near to the indexed replacement position.

2. The method as claimed in claim 1, characterized in that it comprises a second replacement stage (E2) which is commenced at the end of the first stage (E1) when the blow molding station (14) has been taken offline and during which:
at a first indexing and opening phase (P1), a mold carrier (22) is stopped in an indexed angular replacement position;
then, at a second removal phase (P2), the molding elements (18A, 20A) of the first mold (16A) carried by said mold carrier (22) are removed then stored unmated on a second clear intermediate storage support (42, 47);
then, at a third mounting phase (P3), the molding elements (18B, 20B) of one of the second molds (16B) which was stored at the first preparation stage (E1) is mounted on said mold carrier (22).

3. The method as claimed in claim 2, characterized in that it comprises a third storage stage (E3) during which the first molds (16A) removed during the second stage (E2) are mated then stored in the first storage means, with the third storage stage (E3) being commenced once all the first molds (16A) have been removed and once the blow molding station (14) has been put back online to produce containers using the second molds (16B).

4. A dynamic storage device (44) for implementing the method as claimed in claim 1, characterized in that it comprises a plurality of intermediate storage supports (54) each of which is designed to hold the unmated molding elements (18, 20) of a mold (16), and in that the intermediate storage supports (54) are mobile.

5. The dynamic storage device (44) as claimed in claim 4, characterized in that the intermediate storage supports (54) are movably mounted along a closed circuit.

6. The dynamic storage device (44) as claimed in claim 4, characterized in that it comprises at least one intermediate storage support (47) more than the number of mold carriers (22) provided in the blow molding station (14) so that there is one clear storage support (47) available at all times to deposit the molding elements removed from a first mold (16A).

7. The dynamic storage device (44) as claimed in claim 4, characterized in that the travel of the intermediate storage supports (54) is synchronized with the rotation of the carousel (26) of the blow molding station (14) so that the clear intermediate storage support (47) and a storage support (54) carrying a second mold (16B) are moved up to a fixed work position located near to the mold carrier (22) fitted with a first mold (16A) stopped in its angular changeover position.

8. The dynamic storage device (44) as claimed in claim 5, characterized in that the intermediate storage supports (54) are carried by a carousel.

9. The dynamic storage device (44) as claimed in claim 8, characterized in that the carousel is a horizontal carousel.

10. The dynamic storage device (44) as claimed in claim 4, characterized in that the intermediate storage supports (54) are carried by at least one horizontal conveyor (46, 48, 50, 52).

11. The dynamic storage device (44) as claimed in claim 8, characterized in that the carousel is a vertical carousel in which the intermediate storage supports (54) are formed or carried by platforms (70).

12. A dynamic storage device (44) for implementing the method as claimed in claim 2, characterized in that it comprises a plurality of intermediate storage supports (54) each of which is designed to hold the unmated molding elements (18, 20) of a mold (16), and in that the intermediate storage supports (54) are mobile.

13. The dynamic storage device (44) as claimed in claim 5, characterized in that it comprises at least one intermediate storage support (47) more than the number of mold carriers (22) provided in the blow molding station (14) so that there is one clear storage support (47) available at all times to deposit the molding elements removed from a first mold (16A).

14. The dynamic storage device (44) as claimed in claim 5, characterized in that the travel of the intermediate storage supports (54) is synchronized with the rotation of the carousel (26) of the blow molding station (14) so that the clear intermediate storage support (47) and a storage support (54) carrying a second mold (16B) are moved up to a fixed work position located near to the mold carrier (22) fitted with a first mold (16A) stopped in its angular changeover position.

15. The dynamic storage device (44) as claimed in claim 6, characterized in that the travel of the intermediate storage supports (54) is synchronized with the rotation of the carousel (26) of the blow molding station (14) so that the clear intermediate storage support (47) and a storage support (54) carrying a second mold (16B) are moved up to a fixed work position located near to the mold carrier (22) fitted with a first mold (16A) stopped in its angular changeover position.

16. The dynamic storage device (44) as claimed in claim 6, characterized in that the intermediate storage supports (54) are carried by a carousel.

17. The dynamic storage device (44) as claimed in claim 7, characterized in that the intermediate storage supports (54) are carried by a carousel.

18. The dynamic storage device (44) as claimed in claim 5, characterized in that the intermediate storage supports (54) are carried by at least one horizontal conveyor (46, 48, 50, 52).
